(19) United States
(12) Patent Application Publication
(10) Pub. No.: US 2004/0018422 A1
(43) Pub. Date: Jan. 29, 2004

(54) Device including flexible battery and method of producing same

(76) Inventors: Quazi Towhidul Islam, Richmond, VA (US); Arnys Clifton Lilly, Chesterfield, VA (US); William Randolph Sweeney, Richmond, VA (US); Dennis A. Austin, Richmond, VA (US)

Correspondence Address: Peter K. Skiff, BURNS, DOANE, SWECKER & MATHIS, L.L.P., P.O. Box 1404, Alexandria, VA, 22313-1404, US

(21) Appl. No.: 10/201,272

(22) Filed: Jul. 24, 2002

(51) Int. Cl. H01M 6/40; H01M 10/00; H01M 14/00

(52) U.S. Cl. 429/127; 429/124; 429/9; 429/7; 29/623.1

(57) ABSTRACT

The present invention is a device including a flexible battery and the method of producing the device. The device is produced by a method similar to gravure printing. Various layers such as battery layers, solar cell layers, active display layers, conductive layers, electronic layers, and semiconductor layers may be combined using adhesion, or similar processes. The devices of the invention may be printed on various polymers or other suitable materials providing low-cost, high-yield production capabilities. The device may then be formed into a variety of useful items, such as signs, packaging, casing, or other desirable forms.

### FIELD OF THE INVENTION

The present invention relates generally to a flexible, multi-layer, battery, containing a battery layer, and an electronics layer printed on a flexible substrate.

### BACKGROUND OF THE INVENTION

Portable electronic devices have increased in popularity with the recent advancements in electronic technology. As the popularity of portable electronic devices has increased, the need for portable power sources has also increased. Some such portable electronic devices requiring portable power sources include portable computers, portable music devices, cellular telephones, and others. In many instances, the development of portable electronic devices has been limited by the development of the power sources used to power the devices. For example, a significant portion of a portable computer's size and weight is often governed by the batteries that it uses. The size of cellular telephones, for example, is often dictated by the size of the batteries used to power the telephones. The duration of time that any portable electronic device may be used is limited by the lifetime of the battery.

Flexible batteries have been developed, which are bendable, lightweight, and output high energy. One example of a flexible battery is illustrated in U.S. Pat. No. 5,811,204 to Nitzan.

There is a need in the art of portable electronic devices for improvement in weight savings and reduction in manufacturing costs. The invention fills this need by providing a multi-layered, flexible, interactive battery that contains a battery layer and an electronics layer, both of which are flexible to allow for portable electronic devices that fully utilize the advantages of flexible batteries. The invention also minimizes the cost in producing such an interactive battery, by utilizing an inexpensive method for printing the various components of the battery and electronics layers of the interactive battery on a flexible substrate.

### SUMMARY OF THE PRESENT INVENTION

The invention provides a flexible, multi-layered, interactive battery which includes a printed, polymeric semi-conductor layer, a thin, flexible battery layer, and a protective outer barrier layer. In a preferred embodiment, the battery layer includes of an anode, a cathode, at least one electrolyte sub-layer, and a protective sublayer. The protective outer barrier layer preferably fully encloses the printed electronics on the polymeric, semi-conductor layer, and the battery layer so as to protect it from external forces.

The invention also provides a method for making a multi-layered, interactive battery by a web process, using a flexible battery layer as a substrate, adjoining additional layers to the battery layer using transfer and adhesion, and laminating these layers together to provide an outer, protective layer. In a preferred embodiment, the method for creating the interactive battery of the present invention uses a printing process similar to gravure printing, which utilizes transfer and adhesion techniques at room temperature, and is relatively inexpensive. In such an embodiment, electronics may be printed directly on the outside of a plastic medium in a continuous printing process thereby lowering the production cost of the material. Gravure printing is known for its fine detail and high-contrast pigment capabilities, which when used in connection with electronics, can be advantageous for producing devices of decreased feature sizes.

Additional layers may be added to the multi-layer, interactive battery to increase functionality. For example, the battery layer may be a primary or a secondary, rechargeable, battery. In an embodiment of the present invention where the battery layer is a rechargeable battery, a solar cell layer may be added to the multi-layer, interactive battery to provide a way of recharging the battery layer, and to optionally provide additional power to the electronics layer. Solar cells may take on various shapes and sizes, as will be described hereinafter with greater detail.

In one embodiment of the present invention, a device layer may be added to the interactive battery to provide various electronic capabilities. The device layer would be configured to interact with the electronic layer and to receive power from the battery layer. For example, one embodiment of the invention provides for a display layer powered by the battery layer, which is configured to display various information. A display layer may utilize various technologies such as active ink, electronic ink, liquid crystal display (LCD), light emitting diode (LED), electrophoretic display, gyricon display, twisting ball panel display, electrocapillary display, or any number of a variety of different electrically driven display devices.

It is anticipated that device layers may include emitting or receiving devices that emit or receive different types of radiation such as radio frequency (RF) transmissions, infrared (IR) transmissions, audio transmissions, or any number of other transmissions. It is also anticipated that various input devices may be configured to respond to touch, galvanic skin response, electrical contact, or other stimuli.

Further features of the invention, and advantages offered thereby, are explained in greater detail hereinafter with reference to specific embodiments illustrated in the accompanying drawings.

### BRIEF DESCRIPTION OF THE DRAWINGS

FIG. 1A shows an exemplary flexible, multi-layer, interactive battery according to one embodiment of the present invention and FIG. 1B shows a multi-layer battery configuration which can be used for the battery layer in FIG. 1A.

FIG. 2 shows an exemplary flexible, multi-layer, interactive battery containing a device layer according to one embodiment of the present invention.

FIG. 3 shows an exemplary flexible, multi-layer, interactive battery containing a device layer and a solar cell layer according to one embodiment of the present invention.

FIG. 4 shows an exemplary flexible, multi-layer, interactive battery containing an active display layer according to one embodiment of the present invention.

FIG. 5 shows an exemplary method for making a roll of flexible display devices in accordance with one embodiment of the present invention.

FIG. 6 shows an exemplary method for making a display packaging device in accordance with one embodiment of the present invention.

FIG. 7 shows an exemplary packaging made from a flexible display device in accordance with one embodiment of the present invention.

FIG. 8 shows an exemplary interconnection between layers of a flexible, multi-layer, interactive battery in accordance with one embodiment of the present invention.

### DETAILED DESCRIPTION OF PREFERRED EMBODIMENTS

To facilitate an understanding of the principles and features of the present invention, it is explained hereinafter with reference to specific, illustrative embodiments thereof. It will be appreciated, however, that the following embodiments are not the only embodiments in which the invention can be implemented. Rather, it can find utility in a variety of embodiments and configurations, as will become apparent from an understanding of the principles that underscore the invention.

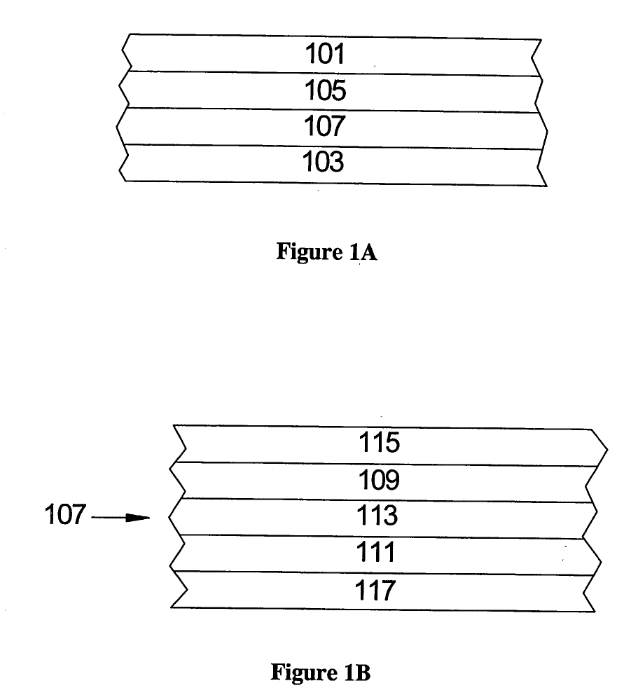

One embodiment of the present invention can be seen in FIG. 1A wherein an exemplary flexible, multi-layer, interactive battery is schematically represented. As shown in FIG. 1A, this interactive battery comprises several layers enclosed by outer barrier layers 101 and 103. Within these outer barrier layers, is a printed polymeric semi-conductor layer 105 and a battery layer 107. The semi-conductor layer 105 is designed, or “printed” using a web process similar to gravure printing.

As shown in FIG. 1B, the battery layer 107 is made up of several sublayers, including electrode sublayers 109 and 111 and an electrolyte sublayer 113, which are surrounded by protective sublayers 115 and 117. The electrolyte sublayer 113 is disposed between the two electrode sublayers 109 and 111, one being an anode and the other being a cathode. The positions of the anode and cathode may be reversed within the battery layer without departing from the spirit of the invention, and is determined by the electronic functionality that is desired. The battery layer 107 may comprise various materials for the electrode sublayers 109 and 111. One common type of battery, a lithium-ion (Li-ion) battery may be implemented by utilizing lithium bonded to a copper grid as one electrode sublayer, and ionized carbon as a second electrode sublayer. The electrolyte sublayer 113 disposed between the two electrode sublayers may be composed of a porous open cell polymer that allows for electron migration between electrodes. However, other materials such as nickel and cadmium may form the electrode sublayers. It is also anticipated that the electrode and electrolyte sublayers may be slurry or liquid sublayers.

In accordance with one embodiment of the present invention, it is preferred that at least one of the outer layers shown in FIG. 1A is made up of a transparent polymer. The outer barrier layers 101 and 103 are laminated together so as to protect the inner layers from external forces. The printed polymeric semi-conductor layer 105 is a semi-conductor printed on a flexible plastic medium, which may be the protective sublayer 115, 117 of the battery layer 107, allowing for processing of a large quantity of the polymer as a web process. The printing of the semiconductor on the polymer may take place using a process similar to gravure printing which utilizes rolls engraved with a pattern desired to be printed and allows for high- definition detail and inexpensive room temperature transfer and adhesion processing.

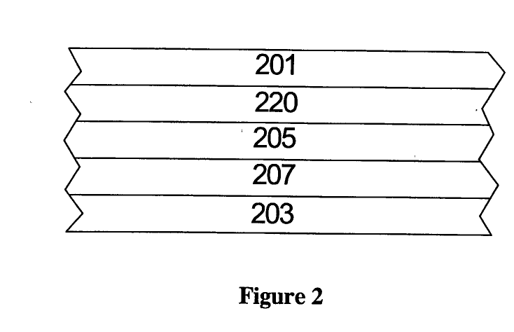

FIG. 2 shows an exemplary flexible, multi-layer, interactive battery with a device layer 220. The device of FIG. 2 is analogous to the device of FIG. 1 in that it also has a printed polymeric semi-conductor layer 205, a battery layer 207, and is surrounded by outer barrier layers 201 and 203, which are laminated together to protect the internal layers. The batter layer 207 is made up of multiple sublayers, not shown in FIG. 2, analogous to the sublayers shown in conjunction with the battery layer 107 of FIG. 1B.

In addition to layers similar to those shown in FIG. 1, the device of FIG. 2 also contains a device layer 220. The device layer 220 may contain devices that are controlled by the electronics of the printed polymeric semi-conductor layer 205 and powered by the battery layer 207. Examples of such devices might include input devices, such as radiation receivers for RF or IR signals, audio receivers, external electric signal receivers, sensors for detecting touch or galvanic skin response, or output devices, such as display devices, radiation emitters for RF or IR signals, or audio emitters. Some display devices, which may be used in the device layer 220 include: LCDs, LED display, electrophoretic display devices, active ink devices, electronic ink devices, twisting ball panel display devices, electrocapillary display devices, or the like. The device layer 220 is preferably a flexible electronic device that is controlled by the semi-conductor layer 205 and powered by the battery layer 207 and may be adjoined with these layers by way of a web process. It should be appreciated, as with the battery shown in FIG.1A, that the battery layer may power external devices by way of connections through the outer barrier layers 201 and 203. The device layer 220 is shown next to the printed polymeric semi-conductor layer 205 for the sake of convenience only. If desired, the layers contained within the outer barrier layers 201 and 203 can be arranged in other configurations in order to address the functionality required and manufacturing constraints.

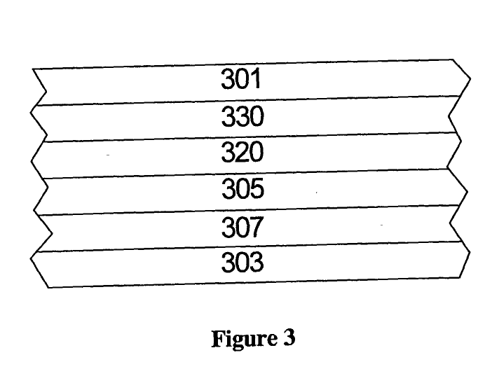

FIG. 3 is an exemplary flexible, multi-layer, interactive battery with a device layer and a solar cell layer. This interactive battery is similar to the device of FIG. 2 and contains analogous layers and an additional solar cell layer 330. As with the device of FIG. 2, the battery shown in FIG. 3 comprises multiple layers enclosed by outer barrier layers 301 and 303, which are laminated together to protect the inner layers. Also, as in FIG. 2, a printed polymeric semi-conductor layer 305, a battery layer 307 containing multiple sublayers similar to the battery layer 107 in FIG. 1B, and a device layer 320 similar to the layers shown in FIG. 2 are contained within the multi-layer, interactive battery. Although solar cell layer 330 is shown next to the device layer 320 in FIG. 3, this layer may be positioned anywhere within the outer barrier layers 301 and 303. As with the layers shown in FIGS. 1 and 2, it is preferred that some of the layers of FIG. 3 be composed of a transparent, flexible material such as a polymer that may be processed using a web processing technique similar to that used in gravure printing.

While the solar cell layer 330 may be placed anywhere between the outer barrier layers 301 and 303, it is preferred that this layer is placed in a position such that it may receive the maximum amount of light, such as nearest one of the barrier layers 301 or 303. The solar cell layer 330 may be connected to the battery layer by way of an electrical via, “windowing” or another interconnection scheme for the purpose of recharging the battery. It is also anticipated that the solar cell layer 330 may be composed of several sublayers of solar cells such that light transmitted through the first sublayer of solar cells will be captured by the second sublayer of solar cells and light transmitted through the second sublayer of solar cells will be captured by the third sublayer of solar cells, and so on, allowing for a higher overall conversion efficiency from light energy to electrical energy for the recharging of the battery layer.

In another embodiment of the present invention, which is not shown, the solar cell layer can be substituted for the outer barrier layer 301 such that it receives the maximum amount of light. In this embodiment, a solar cell layer would be laminated with either an outer barrier protective layer 303 or another solar cell layer substituted for this layer such that the combination of laminated layers encloses the inner layers of a multilayer interactive battery. This configuration is advantageous because the conversion efficiency of the solar cell layer in converting light energy into electrical energy is increased because there are no obstructions between the solar cell layer and the ambient light, and the overall size of the battery is decreased by eliminating layers.

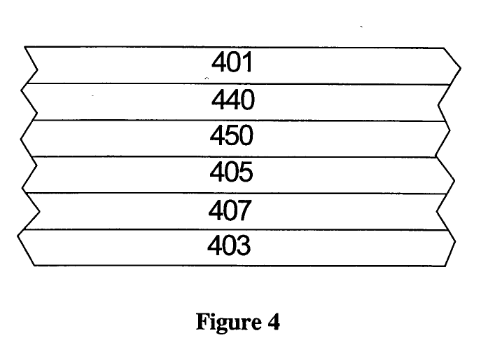

FIG. 4 shows an exemplary flexible, multilayer, interactive battery with an active display layer utilizing an active ink technology. As with the device as shown in FIGS. 1-3, the multilayer, interactive battery of FIG. 4 comprises multiple layers including outer barrier layers 401 and 403, which are laminated to enclose and protect inner layers including a printed polymeric semiconductor layer 405 and a battery layer 407 containing multiple sublayers as shown in FIG. 1. Each of these layers of the device shown in FIG. 4 is analogous to those layers discussed in connection with the devices in FIGS. 1-3. Additionally, the embodiment of the present invention shown in FIG. 4 includes an active ink layer 450, which is powered by a conductive layer 440. It is preferable that the conductive layer 440 and the active ink layer 450 are made of thin, flexible, transparent polymer material that is easily processed using a web process. However, it is anticipated that other materials may be utilized as the conductive layer or active ink layer without departing from the spirit of the invention, as will be apparent to those skilled in the art.

The active ink layer 450 may utilize a variety of current technologies. Some of these technologies include gyricon devices, twisting ball displays, electrocapillary displays, and electrophoretic display devices. In a preferred embodiment of the present invention, the active ink layer 450 utilizes an electrophoretic display device. An electrophoretic device is advantageous in the configuration of the device shown in FIG. 4 because it is voltage driven, which works well with the printed polymeric semiconductor since such devices cannot withstand large amounts of current. Generally, flexible batteries like those and illustrated in FIGS. 1-4 can be about 50-100 micron thick, although this dimension may vary greatly as various layers are added.

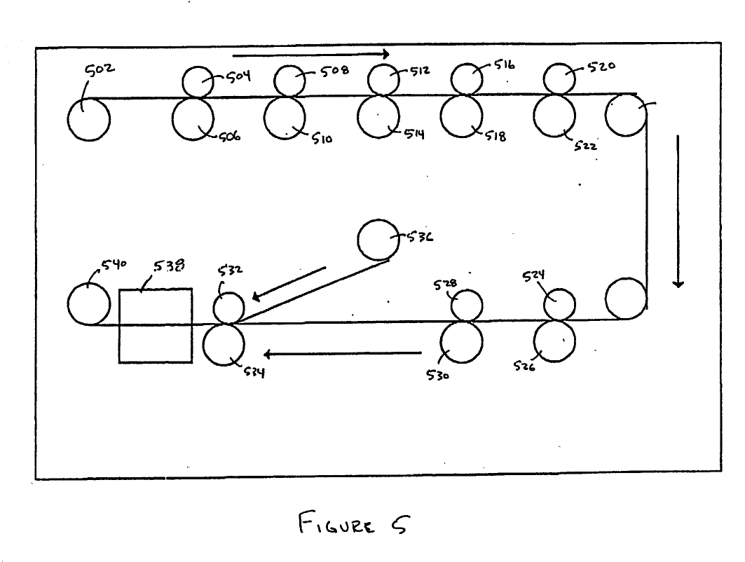

FIG. 5 illustrates a possible method for making a roll of flexible display devices utilizing a battery layer as a substrate in a web process similar to gravure printing. The method utilized in FIG. 5 is similar to the web-fed gravure press utilized in printing. In gravure printing, a roll of substrate is unwound from an unwinder roll, which serves the purpose of maintaining adequate tension on the web of substrate material to be processed. Other components generally included in a gravure printing press include an image carrier, which is a cylinder engraved with an image to be printed or transferred to the substrate; an ink fountain, which is a large inkwell positioned beneath the cylinder extending the width of the press unit; a doctor blade assembly containing a blade which wipes excess ink from the non-image areas of the image carrier; an impression roller, which is a rubber-covered metal cylinder that holds the substrate against the engraved image carrier to obtain proper ink transfer; and a dryer, which utilizes a controlled source of heated air to provide optimum drying. This system is physically simple and requires relatively few components making the images printed thereby inexpensive and readily mass produced.

As with gravure printing, the process of combining the layers of the flexible, multi-layered, interactive battery with an active display device, similar to the device shown in FIG. 4, uses an unwind plastic roll 502 to unwind the battery layer material for use as a substrate whereupon various additional layers and components may be added. At subsequent rolls, the substrate receives new layers which are adhered to the original substrate. At rolls 504 and 506 barriers are applied to the substrate. These barriers are generally gas barriers, which protect and insulate the battery layer substrate from external elements, such as chemicals, moisture, and gases. At rolls 508 and 510 conductors are added to the substrate and barrier layers. These conductors are the electrical pathways that provide operating voltage to the display layer. These conductors may be applied by printing, vapor deposition, sputtering, or other suitable techniques. At rolls 512 and 514 a protective coat is applied. This protective coat is a protective and insulative adhesion binder that binds the conductor and display pigment. In addition, the protective coat provides chemical and electrical insulation for the display layer. At rolls 516 and 518 display pigment is added and bound using the adhesion binder protective coat. If desired, this display pigment may be any voltage-controlled display pigment.

At rolls 520 and 522 conductors are added which provide the operating voltage for the display layer in connection with the conductors added at rolls 508 and 510. At rolls 524 and 526 transistors are added to control the display device. These transistors may be created using a number of technologies, such as printing polymeric semiconductor elements on a polymer substrate. At rolls 528 and 530, barriers are added, which are similar to those added at rolls 504 and 506, and which provide protection and insulation from external elements. At rolls 532 and 534, lamination occurs, laminating outer barrier layer plastic from a second unwind plastic roll 536. Lamination provides a seal at the edges, and may be accomplished using heat, ultrasonic welding, UV-light curing, or other methods suitable for providing a protective seal at the edges of the battery.

Testing is performed by station 538. The completed flexible display device is then wound onto roll 540. Testing may be used to determine that electrical pathways are conducting correctly, or that the device is functioning properly. For example, a specific pattern such as a checkerboard or other suitable pattern, may be displayed on the display device to indicate that it is functioning properly. This pattern may be monitored and verified by a camera or imaging device in the testing station 538. Any device found to be defective can then be marked by magnetic ink, or other identifying marker.

It will be recognized by those skilled in the art, that various changes in the process described in connection with FIG. 5 may be implemented without departing from the spirit of the invention. For example, various layers may be added or subtracted from the process, or the order of layers may be changed without departing from the spirit of the invention.

One of the advantages of creating a flexible, self-powered display device by an inexpensive method such as the one shown in FIG. 5, is that such a display device can be disposable. Traditional electronic displays, such as the LCDs used in calculators and wristwatches cost about $100 per square foot, while the flexible display device of the present invention can be produced at much lower costs, e.g., under $1.00 per square foot, preferably under $0.50 per square foot, more preferably about $0.10 per square foot.

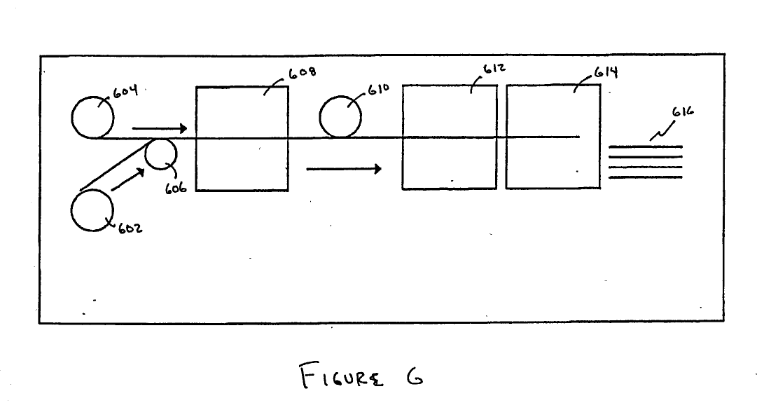

Because of the inexpensive, potentially disposable nature of the flexible, self-powered display device of the present invention, it is possible to use this device as packaging. Traditionally, disposable packages printed using a gravure printing process are used for perishable items such as gum, candy, cigarettes, and others. With the present invention, an interactive package utilizing an active display could be used for these same items and provide a self-powered electronic device within the packaging. This permits such a package to be used for a multitude of different marketing tools. FIG. 6 shows a possible method for making a package display device that could be used as disposable packaging.

In FIG. 6, unwind rolls 602 and 604 can be used similarly to the unwind rolls 502 and 536 in FIG. 5. A rechargeable battery layer, such as the one formed in FIG. 5, is used as a substrate taken up from unwind roll 604, and combined with a solar cell layer from unwind roll 602 at roll 606. These layers are then laminated, electrical interconnects are created, and tests are performed at station 608 in a similar manner as discussed in connection with station 538 in FIG. 5. At roll 610, a flexible active ink display layer is added. At station 612, further lamination occurs, electrical interconnects are established, and the combination is further tested. At folding station 614, cutting and folding of the packaging devices is accomplished, and the packs are then stacked as shown in stack 616 of furnished devices. It will be recognized by those skilled in the art that multiple types of battery layers, solar cell layers, and display device layers may be added without departing from the spirit of the invention. One preferred embodiment of the present invention utilizes a lithium-ion rechargeable battery and an active ink display device utilizing electrophoretic display technology as discussed in association with FIG. 4.

The solar cell layer may be made from a variety of materials suitable for creating a rechargeable, solar cell. The solar cell may contain multiple sub-layers itself, each of which may be configured to absorb particular wavelengths of light. This multi-layered solar cell configuration is advantageous as it increases the efficiency of the solar cell by increasing its overall absorption. One such multi-layered solar cell is a triple-junction, amorphous, silicon alloy solar cell described in the paper, “Triple-Junction Amorphous Silicon Alloy PV Manufacturing Plant of 5 MW Annual Capacity,” by Yang et al., published in 1997 by IEEE.

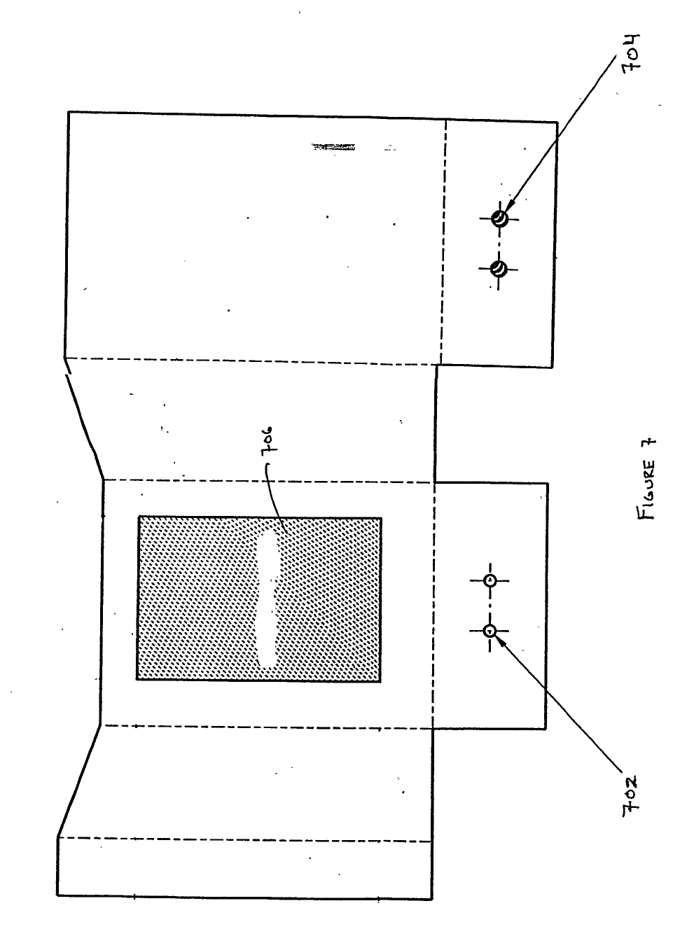

FIG. 7 illustrates a possible design of an interactive packaging device that can be used for cigarettes. It is anticipated that the device shown in FIG. 7 could be created by the method illustrated in FIG. 6. This device may utilize a battery layer, a solar cell layer, and a device layer, which in one embodiment may be a display device layer to create an active display, or any combination of these layers. The dotted lines of FIG. 7 correspond to lines along which the package is folded. It should be noted that for most applications, the battery layer need not occupy the entire surface area of the packaging device to provide adequate power for the desired functionality over the anticipated lifetime. For example, using energy densities of presently available polymer rechargeable batteries, a battery layer occupying the entire surface of the packaging device would provide power for several weeks. However, power density sufficient for a couple of days is all that is desired, which would require a battery layer that occupies only a small portion of the overall area of the package shown in FIG. 7. In FIG. 7, charge and discharge holes 702 are shown as a method for recharging a rechargeable battery layer, and holes 704 are open holes. As with the battery layer, the solar cell layer need not occupy the entire surface of the packaging device. For example, a solar cell may occupy just one side of the package which would be exposed to light. The solar cell could be utilized to border a display device, a battery layer or an open area 706, or it could occupy the entire surface of a packaging device, in which case it would preferably be transparent to allow for a display device to be viewed through the solar cell layer.

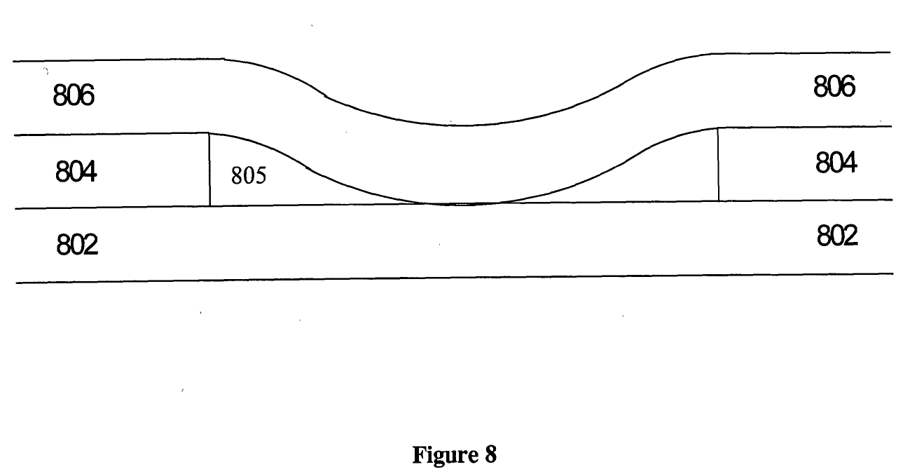

Several methods for providing electrical connection between two layers may be utilized. Traditional electrical vias may be used as electric throughputs from one layer to another. However, due to the flexible nature of the layers, one preferred type of interconnect is provided by a technique called “windowing.” Such an interconnect is easy to manufacture, and inexpensive. An example of a “window” interconnect is shown in FIG. 8, wherein three layers 802, 804 and 806 of a multilayer interactive battery are represented. Layer 804 is disposed between layers 802 and 806. The interconnection shown utilizes a separation 805, or “window,” in layer 804 to provide electrical contact between layers 802 and 806. This interconnection method may be readily adapted for the web processing method that is illustrated in FIGS. 5 and 6 for use of the present invention. By using this process, the pressure of various rolls used to adjoin layers to the battery layer substrate, as shown in FIGS. 5 and 6 is sufficient to adhere layers 802 and 806 together and provide electrical contact. In this manner, the room temperature transfer and adhesion techniques utilized by web processing are sufficient to create an electrical contact without the use of heat, solder, or other traditional methods for making electrical contacts.

From the foregoing, it can be seen that the present invention provides a flexible, multi-layer, interactive battery and a method for making the same. In one embodiment, the multilayer battery is made from flexible polymers and comprises various layers including a battery layer, a solar layer for recharging the battery layer, a printed polymeric semiconductor layer that provides electronic capabilities, a device layer, which may include a variety of different types of electronic devices, surrounded by outer barrier layers, laminated together to protect the inner layers.

One preferred embodiment of the invention utilizes a display device as a device layer allowing for an active display, powered by the battery layer and controlled by the semiconductor layer. This flexible, multi-layer, interactive battery is created utilizing a method of web processing similar to gravure printing, which allows for its inexpensive mass production. Because the battery is inexpensive to produce, a convenient use is as disposable packaging, which is traditionally printed by gravure printing. This creates a multitude of possibilities for various interactive, self-powered, electronic, disposable packaging devices. One example is a disposable package such as a carton for perishable commodities like cigarettes. However, it will be apparent to those skilled in the art that many useful devices may be created by forming the interactive battery of the present invention into a variety of specific useful shapes:

One example of a use for the interactive battery is as an electrical sign, which may be self-powered, self-recharging, and could be controlled either by computer or telemetry according to the devices of the battery's device layer. For example, the present invention, utilizing a display layer and a solar cell layer, could create a transparent polymer sign, which could be adhered to a window, where the solar cells could absorb sunlight, and the display layer could advertise various products. Alternatively, the interactive battery of the present invention with an active display device layer could be utilized to create wallpaper, which changes its appearance from time to time. This wallpaper could be controlled either by a direct computer connection, telemetry, or galvanic skin response to provide a variety of appearances pleasing to the user.

In one embodiment, using the present invention as a packaging device for perishable commodities, a device layer could be added to allow for advertisement of the commodities contained within the packaging. This type of advertising could be used while the commodity is on the shelf, attracting the immediate attention of potential purchasers in the store. For example, utilizing an active display device, an interactive package could provide price information which may change in accordance with various promotions and sales offered by the store in which it is being sold. It is conceivable that a sale itself could be announced by utilizing the active display device of a package creating a visual effect that could be coordinated with the various neighboring interactive packaging, to attract a buyer's attention. It is further contemplated that an audio device layer may be added to the interactive battery used as a packaging device to provide audio announcements such as promotions and corresponding pricing information.

The present invention may also replace other plastic devices, thereby eliminating the need for space in a device dedicated for a power supply. For example, the very casing and display of a cellular telephone may be utilized as a battery and created by the present invention. Also, the size of a laptop computer may be dramatically reduced by providing much of the power supply needs, the display, and electronics required for the device within the structure of the device itself. It is possible to use the interactive battery of the present invention as a book cover, or binder, which may be used for promotion or identification purposes. Indeed, any device which may be formed by the multilayer, interactive battery of the present invention may be replaced by it, thereby adding to functionality and diminishing the need for additional space normally wasted using conventional batteries as power devices.

The presently disclosed embodiments are therefore considered in all respects to be illustrative and not restrictive. The scope of the invention is indicated by the appended claims, rather than the foregoing description, and all changes that come within the meaning and range of equivalence thereof are intended to be embraced therein.

What is claimed is:

1. A flexible, multi-layered, interactive battery comprising: a printed, polymeric semiconductor layer adjoined with a thin, flexible battery layer comprising:
a cathode sublayer,
an anode sublayer,
at least one electrolyte sublayer disclosed between said cathode and anode sublayers, and
wherein said layers are enclosed by an outer barrier layer.

2. The interactive battery of claim 1, further comprising a barrier layer.

3. The interactive battery of claim 1, wherein said battery layer comprises a polymer battery layer.

4. The interactive battery of claim 1, wherein said battery layer comprises a primary battery layer.

5. The interactive battery of claim 1, wherein said battery layer comprises a secondary battery layer.

6. The interactive battery of claim 5, wherein said battery layer comprises a lithium-ion (Li-ion) battery layer.

7. The interactive battery of claim 5, wherein said battery layer comprises a nickel cadmium (Ni—Cd) battery layer.

8. The interactive battery of claim 5, further comprising a solar cell layer operatively connected to said battery layer.

9. The interactive battery of claim 1, further comprising an electronic device layer.

10. The interactive battery of claim 9, wherein said electronic device layer comprises an output device.

11. The interactive battery of claim 10, wherein said output device comprises a display device.

12. The interactive battery of claim 11, wherein said display device comprises an active display device.

13. The interactive battery of claim 12, wherein said active display device is an electrophoretic display device.

14. The interactive battery of claim 12, wherein said active display device is a twisting ball display device.

15. The interactive battery of claim 12, wherein said active display device comprises an electrocapillary display device.

16. The interactive battery of claim 11, wherein said display device comprises an LCD device.

17. The interactive battery of claim 11, wherein said display device comprises an LED display device.

18. The interactive battery of claim 10, wherein said output device comprises an emitter.

19. The interactive battery of claim 18, wherein said emitter is configured to emit radiation.

20. The interactive battery of claim 19, wherein said radiation comprises radio frequency (RF) radiation.

21. The interactive battery of claim 19, wherein said radiation comprises infrared (IR) radiation.

22. The interactive battery of claim 18, wherein said emitter is configured to emit audio signals.

23. The interactive device of claim 9, wherein said electronic device comprises an input device.

24. The interactive battery of claim 23, wherein said input device comprises a receiver.

25. The interactive battery of claim 24, wherein said receiver is configured to receive radiation.

26. The interactive battery of claim 25, wherein said radiation is RF radiation.

27. The interactive battery of claim 25, wherein said radiation is IR radiation.

28. The interactive battery of claim 24, wherein said receiver is configured to receive audio signals.

29. The interactive battery of claim 23, wherein said input device comprises a sensor.

30. The interactive battery of claim 1, wherein windows between non-adjacent layers are provided, and the non-adjacent layers are electrically connected through said windows.

31. The interactive battery of claim 9, further comprising at least one conductive layer disposed adjacent to said device layer.

32. The interactive battery of claim 1, wherein two, non-adjacent layers are electrically connected through a removed portion of any interposing layers.

33. A method for making a multi-layered, interactive battery by a web process comprising the steps of:
providing a flexible battery layer taken from an unwind roll which provides tension to the battery layer;
using the battery layer as a substrate;
adjoining one or more sub-layers to the battery layer by transfer and adhesion at individual processing rolls;
laminating additional layers and said battery layers together to provide an outer, protective layer.

34. The method of claim 33, wherein said battery layer comprises a polymer battery layer, and said method includes using said polymer battery layer as a substrate.

35. The method of claim 33, wherein said battery layer comprises a primary battery layer, and said method includes using said primary battery layer as a substrate.

36. The method of claim 33, wherein said battery layer comprises a secondary battery layer, and said method includes using said secondary battery layer as a substrate.

37. The method of claim 33, wherein said additional layers comprise a semiconductor layer, and said method includes laminating said semiconductor layer together with said battery layer.

38. The method of claim 33, wherein said semiconductor layer comprises a polymeric semiconductor layer, and said method includes laminating said polymeric semiconductor layer together with battery layer.

39. The method of claim 33, wherein said semiconductor layer is printed utilizing web processing techniques, and said method includes printing said semiconductor layer on the substrate formed by said batter layer.

40. The method of claim 33, wherein said additional layers comprise an electronic device layer, and said method includes laminating said electronic device layer together with said battery layer.

41. The method of claim 40, wherein said electronic device layer comprises a display, and said method includes laminating said display together with said battery layer.

42. The method of claim 41, wherein said display comprises an active display, and said method includes laminating said active display together with said battery layer.

43. The method of claim 42, wherein said active display comprises an electrophoretic display device, an electrocapillary display device, a gyricon display device, or a twisting ball display device, and said method includes laminating said active display together with said battery layer.

44. The method of claim 33, wherein said additional layers comprise a conductive layer, and said method includes laminating said conductive layer together with said battery layer.

45. The method of claim 33, wherein said additional layers comprise a solar cell layer, and said method includes laminating said solar cell layer together with said battery layer.

46. The method of claim 33, further comprising the step of creating electrical connections between two non-adjacent layers by removing a portion of any layers disposed between the two layers and pressing together the two layers.
